(19) United States
(12) Patent Application Publication
(10) Pub. No.: US 2024/0242875 A1
(43) Pub. Date: Jul. 18, 2024

(54) ASYMMETRIC DELTA MULTI-PULSE TRANSFORMER RECTIFIER UNIT, AND ASSOCIATED SYSTEMS AND METHODS

(71) Applicant: ELDEC CORPORATION, Lynnwood, WA (US)

(72) Inventors: Randy STEPHENSON, Lynnwood, WA (US); Travis SITTON, Lynnwood, WA (US); Patrick ROCHE, Lynnwood, WA (US)

(73) Assignee: ELDEC AEROSPACE CORPORATION, Lynnwood, WA (US)

(21) Appl. No.: 18/559,284

(22) PCT Filed: May 6, 2022
(86) PCT No.: PCT/US2022/028159

§ 371 Date: Nov. 6, 2023

Related U.S. Application Data
(60) Provisional application No. 63/185,520, filed on May 7, 2021.

(51) Int. Cl. H01F 27/28; H01F 27/40; H01F 30/12; H02M 1/42

(52) U.S. Cl. CPC H01F 27/2823; H01F 30/12; H02M 1/4216; H01F 2027/408

(57) ABSTRACT

Asymmetric multi-pulse transformer rectifier unit (TRU), and associated systems and methods are described herein. In some embodiments, the transformer includes a 3-phase delta or wye primary coupled to a galvanically isolated 3-phase delta secondary with correction windings placed per the transformer schematic to provide a multi-pulse (e.g., 18-pulse or 24-pulse) asymmetric output. Such construction provides passive multiphase PTC and harmonic cancellation and allows multi pulse rectification. At the TRU level. 3-phase input power is provided to the transformer, which produces an isolated 9-phase or 12-phase output. The isolated multi-phase transformer output may be fed into a bridge rectifier, which converts AC to DC. DC output voltage may be determined by AC input voltage and transformer turns ratio.

### CROSS-REFERENCE(S) TO RELATED APPLICATION(S)

This application claims priority to U.S. Provisional Patent Application No. 63/185,520, filed May 7, 2021, which is incorporated by reference herein in its entirety.

### BACKGROUND

Commercial aircraft continue to evolve into More Electric Aircraft (MEA), featuring increased electrical content in place of hydraulic and pneumatic systems. Recent advances in the fields of power electronics and high-density electric motors, along with continued pressure to reduce operating costs, ensure that this trend will continue. Furthermore, the aircraft propulsion is moving toward hybrid-electric, turbo-electric, and even all-electric powertrains. Under some scenarios, the move to electric propulsion is expected to increase electrical system power demand by greater than forty times.

Modern aircraft continue to increase power demand from aircraft low voltage (typically 28V) and high voltage (typ. 270V, 540V, or greater) DC buses. Increased proportion of electrical power demand from AC generators by DC buses requires increased AC to DC converter power quality to mitigate undesirable effects like AC bus voltage distortion and generator harmonic torque.

Aircraft 28V buses are conventionally sourced by Transformer Rectifier Units (TRUs). These TRUs convert 3-phase AC voltage provided by aircraft generators to a nominal 28 VDC. The primary functional blocks of the TRU are the transformer and the bridge rectifier. The transformer provides multiphase Power Factor Correction (PFC), galvanic isolation, and voltage step-down prior to bridge rectification. The bridge rectifier rectifies the transformer AC phase outputs, converting output voltage to DC.

Some conventional 28V TRU systems rely on one primary (wye or delta) with two secondaries, a wye and a delta, to establish 6 AC output phases (allowing 12-pulse rectification) that are converted to a DC voltage. Due to low minimum secondary turns count (7 turns per delta winding, 4 turns per wye winding) this is effective at providing high current output (200-300 A). However, this approach requires use of an interphase transformer (resulting in increased weight and reduced efficiency) to reduce output voltage ripple and account for natural voltage imbalance between the delta and wye secondaries, and only 12-pulse power quality can be achieved.

Other conventional TRU designs use multiple transformers with complementary zig-zag secondary windings to provide better than 12-pulse power quality. High output current and excellent power quality can be achieved with this approach, but use of multiple transformers with complex windings significantly increases manufacturing cost, increases weight, and reduces overall power density.

Some conventional methods rely on a delta primary and a hexagonal secondary to provide 24-pulse power quality with use of simpler discrete output inductors rather than complex interphase transformers. This approach provides a high performance and weight-competitive solution for lower current (<200 A) TRUs, but high minimum secondary turns count (66 turns for best harmonic performance, 48 turns bare-minimum) causes high leakage inductance and resistive loss in the transformer, resulting in low efficiency, high weight, and poor output voltage regulation in high current (>200 A) applications.

In some conventional applications, aircraft high voltage buses (e.g., 270V or 540V) are sourced by Auto-Transformer Rectifier Units (ATRUs). ATRUs provide passive multiphase PFC and AC to DC conversion, but without galvanic isolation, because ATRUs use autotransformers rather than transformers for multiphase PFC. Since there is no galvanically isolated secondary, autotransformers use primary side correction windings to generate additional phases needed for multiphase PFC. These autotransformers are inherently lighter and more efficient than similarly rated transformers because autotransformers have a significant portion of the power electrically conducted by the windings and not magnetically coupled thru the core. However, unless generator neutral is isolated from airframe, ATRU output return cannot be tied directly to airframe. Since generator neutral is typically referenced to airframe, ATRU output voltage is seen as a split voltage relative to airframe. This is commonly acceptable for high voltage point-of-use loads including motor drives, radar, and de-icing equipment, but this approach creates challenges for wide-spread DC distribution due to high common-mode voltage and inability to reference output voltage independently of input voltage. Since autotransformers cannot provide galvanic isolation, many aircraft applications will require a high voltage TRU (HVTRU). Due to high power levels, 18 pulse or 24 pulse power quality is likely to be required in practical systems. Furthermore the above-described conventional ATRU approaches suffer from one or more of the following shortcomings: high common-mode voltage, only supports loads where return is not tied to airframe, inability to reference output voltage independently of input voltage.

In summary, the above-described conventional 28V TRU approaches suffer from one or more of the following shortcomings: low (e.g., 12 pulse) power quality, required use of interphase transformers, complex assembly processes requiring multiple transformers, high weight, and/or high minimum secondary turns count. On the other hand, modern ATRUs are available with low weight, high efficiency, and excellent power quality (18-24 pulse) without requiring use of interphase transformers, but they cannot provide galvanic isolation between 3-phase AC input and DC output. Accordingly, systems for AC to DC conversion that are capable of providing better than 12 pulse power quality without use of interphase transformers and with galvanic isolation are still needed. Additionally, high current 28V applications need low (<40) secondary turns count to minimize resistive and reactive voltage drop in the transformer.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The inventive technology allows conversion from a 3-phase AC voltage to a DC voltage with the output voltage being proportional to input voltage and the output electrically isolated from the input. For example, the present technology provides a nominal 28 Volt DC, 270 Volt DC, or 540 Volt DC output from a commonly used 115 Volt AC or 230 Volt AC input in modern aerospace power systems. The output voltage is proportional to input voltage and transformer primary-secondary turns ratio.

In some embodiments of the inventive technology, the asymmetric delta secondary transformer topology may be uniquely suited to provide high performance in conjunction with low weight and cost in both HVTRUs and high current 28V TRUs. The asymmetric approach offers substantially reduced weight relative to a symmetric 18P solution, because the correction windings can be made with fewer turns and carry less current than they would in a symmetric delta design.

In some embodiments, the inventive TRU technology allows efficient, lightweight 18 or 24 pulse operation with high voltage output or nominal 28V output. Construction of the transformer may consist of a standard 3-phase delta or wye primary coupled to a galvanically isolated 3-phase delta secondary with correction windings placed per the transformer schematic to provide a 9-phase asymmetric output for the 18-pulse operation or a 12-phase asymmetric output for the 24-pulse operation, therefore providing passive multiphase power phase correction (PFC) and harmonic cancellation and allowing 18-pulse or 24-pulse rectification. Output phases of the individual secondary correction windings are asymmetric such that individual output phase voltages are controlled relative to the opposite secondary delta corner phase, and the secondary output phase voltages are unbalanced relative to secondary neutral. In the context of this specification, secondary delta windings and secondary correction windings are collectively referred to as the secondary windings.

The isolated (e.g., galvanically isolated) 9-phase or 12-phase transformer output may be fed into an 18-pulse or 24-pulse bridge rectifier, which converts the AC to DC. DC output voltage may be determined by AC input voltage and transformer turns ratio. For example, for the 18-pulse TRU, total input current harmonic distortion is expected to be 5-7% in most applications, which is a substantial improvement compared to the 11-14% that is typical of 12 pulse TRUs. The 24-pulse TRU is expected to provide 3-5% total input current harmonic distortion in most applications.

For 28V TRU applications, the inventive technology offers cost reduction relative to the 24P delta-hex solution, and it supports significantly higher output currents than the delta-hex is practically capable of. The inventive technology offers substantial improvements to 28V TRU power quality by providing cancellation of the 11th and 13th harmonics, which commonly require specification deviations for 12-pulse TRUs.

For HVTRU applications, the asymmetric 18-pulse (18P) or 24-pulse (24P) delta approach offers substantially improved power quality relative to 12-pulse (12P) solutions and substantially reduced weight relative to symmetric 18- or 24-pulse solutions. Therefore, the inventive asymmetric 18P and 24P delta transformers offers excellent power quality for low cost and minimal weight penalty.

In high voltage DC applications, the inventive TRU technology utilizes 18-pulse/24-pulse transformer winding topology coupled to a delta or wye primary to provide a galvanically isolated 270 VDC or 540 VDC nominal output with excellent power quality. The inventive technology may result in power density greater than 2.4 kW/kg and efficiency greater than 96%. Despite the addition of galvanic isolation, these numbers are much closer to conventional ATRU technologies (˜3 kW/kg, >97% eff.) than to conventional TRU technologies (<1 kW/kg, >90% eff.). Galvanic isolation between the TRU's AC input and DC output allows the TRU's output return to be tied to airframe, making its use possible in applications requiring a unipolar output. Additionally, the inventive HVDC TRU technology maintains the inherent ruggedness and reliability for aerospace applications. The inventive technology simplifies the system and reduces the risk while still providing excellent performance and low weight.

In one embodiment, a Transformer Rectifier Unit (TRU) includes an asymmetric transformer having: a first coil, a second coil and a third coil. Each coil includes a primary winding and a secondary winding, each secondary winding is an asymmetric secondary winding, and each coil is configured for being energized at its corresponding input phase. The TRU also includes a galvanic isolation electrically isolating primary windings from secondary windings, where: a first secondary winding includes a first secondary delta winding and a first plurality of secondary correction windings coupled to a first primary winding; a second secondary winding includes a second secondary delta winding and a second plurality of secondary correction windings coupled to a second primary winding; and a third secondary winding includes a third secondary delta winding and a third plurality of secondary correction windings coupled to a third primary winding. The TRU also includes a bridge rectifier having a plurality of rectifiers coupled to respective individual correction windings, where output phases of individual secondary correction windings are asymmetric such that individual output phase voltages are controlled relative to an opposite secondary delta corner phase, and where the output phase voltages are unbalanced relative to secondary neutral.

In one aspect, the transformer is an 18-pulse transformer having a 3-phase input power, and an isolated 9-phase output.

In one aspect, each plurality of secondary correction windings includes 2 secondary correction windings.

In one aspect, tap points of each plurality of correction windings separate each corresponding coil of the secondary delta winding into 3 segments.

In one aspect, individual phase voltages are about 20° offset from one phase to a next adjacent phase at the bridge rectifier.

In another aspect, the transformer is a 24-pulse transformer having a 3-phase input power, and an isolated 12-phase output. Each plurality of secondary correction windings comprises 3 secondary correction windings. Tap points of each plurality of correction windings separate each corresponding coil of the secondary delta winding into 4 segments. Individual phase voltages are about 15° offset from one phase to a next adjacent phase at the bridge rectifier.

In one aspect, the bridge rectifier includes: a main rectifier configured for rectifying AC voltages of the secondary delta windings; and a secondary rectifier configured for rectifying AC voltages of the correction windings.

In one aspect, the main rectifier provides about 66% of DC power, and the secondary rectifier provides about 34% of DC power.

In one embodiment, a method for designing an asymmetric transformer is presented. The asymmetric transformer has a first coil, a second coil, a third coil, and a galvanic isolation. Each coil includes a primary winding and a secondary winding. Each secondary winding is an asymmetric secondary winding having a secondary delta winding and a plurality of secondary correction windings. The galvanic isolation is configured for electrically isolating primary windings from secondary windings. The method includes: selecting turns count for the primary windings of the coils; selecting turns count for each of the secondary delta windings of the coils; selecting tap points for secondary correction windings along a first secondary delta winding of the first coil, a second secondary delta winding of the second coil and a third secondary delta winding of the third coil. The tap points divide each of the first secondary delta winding, the second secondary delta winding and the third secondary delta winding into segments. The method also includes constructing transformer vector diagram using an equilateral triangle with leg lengths proportional to a number of turns between secondary corner phases. Each side of the triangle represents one of the first, second and third secondary delta windings. The method also includes drawing lines representing individual secondary correction windings off of each tap location along the first, second and third secondary delta winding. Each line is represented as a vector of a first plurality of vectors with a phase equivalent to a phase of the coil the secondary correction winding is wound upon and length proportional to secondary correction windings turns count. Each vector of the first plurality of vectors runs parallel to one of sides of the triangle. The method also includes determining each secondary correction winding's turns ratio by the length of a corresponding vector of the first plurality of vectors; and determining a number of turns in each second correction winding as a multiple of the turns ratio and the number of turns in the complete secondary delta winding.

In one aspect, the method also includes determining output phases of the transformer by: drawing a vector of a second plurality of vectors from an end of each correction winding vector to an opposite vertex of the equilateral triangle; and determining an output phase of each correction winding by a length of a corresponding vector of a second plurality of vectors.

In one aspect, an output phase of each correction winding is proportional to a magnitude of a corresponding output phase relative to a phase represented by an opposite vertex of the triangle.

In one aspect, the transformer is an 18-pulse transformer having a 3-phase input power, and an isolated 9-phase output. Each plurality of secondary correction windings includes 2 secondary correction windings, and tap points of each plurality of correction windings separate each corresponding coil of the secondary delta winding into 3 segments. Individual phase voltages are about 20° offset from one phase to a next adjacent phase at a bridge rectifier.

In one aspect, the transformer is a 24-pulse transformer having a 3-phase input power, and an isolated 12-phase output.

In one aspect, each plurality of secondary correction windings includes 3 secondary correction windings, and tap points of each plurality of correction windings separate each corresponding coil of the secondary delta winding into 4 segments, and individual phase voltages are about 15° offset from one phase to a next adjacent phase at a bridge rectifier.

### DESCRIPTION OF THE DRAWINGS

The foregoing aspects and the attendant advantages of the inventive technology will be more readily appreciated as the same become better understood by reference to the following detailed description, when taken in conjunction with the accompanying drawings, wherein:

FIGS. 1A and 1B illustrate an 18-pulse asymmetric TRU according to an embodiment of inventive technology;

FIGS. 2A and 2B illustrate a 24-pulse asymmetric TRU according to an embodiment of inventive technology;

FIG. 3 illustrates a delta-wound asymmetric transformer according to an embodiment of inventive technology;

FIG. 4A illustrates primary delta windings of a multi-pulse asymmetric transformer according to an embodiment of inventive technology;

FIGS. 4B and 4C illustrate secondary delta and secondary correction windings of an 18-pulse asymmetric transformer according to an embodiment of inventive technology;

FIG. 4D illustrates secondary delta and secondary correction windings of a 24-pulse asymmetric transformer according to an embodiment of inventive technology;

FIGS. 5-8 illustrate secondary delta and secondary correction windings for an 18-pulse asymmetric transformer according to an embodiment of inventive technology;

FIGS. 9-16 illustrate secondary delta and secondary correction windings for a 24-pulse asymmetric transformer according to an embodiment of inventive technology;

FIG. 17 is a flowchart of a method for designing a multi-pulse asymmetric transformer according to embodiments of inventive technology;

FIG. 18 is a graph of simulated 3-phase input current waveforms for an 18-pulse asymmetric TRU utilizing an ideal transformer of the topology depicted in FIG. 4B;

FIG. 19 is a graph of simulated rectifier bridge currents for an 18-pulse asymmetric TRU utilizing an ideal transformer of the topology depicted in FIG. 4B;

FIG. 20 is a graph of simulated phase A input voltage and current for an 18-pulse asymmetric TRU utilizing an ideal transformer of the topology depicted in FIG. 4B; and

FIG. 21 is a graph of actual 3-phase input current waveforms according to an embodiment of inventive technology.

### DETAILED DESCRIPTION

While illustrative embodiments have been illustrated and described, it will be appreciated that various changes can be made therein without departing from the spirit and scope of the invention.

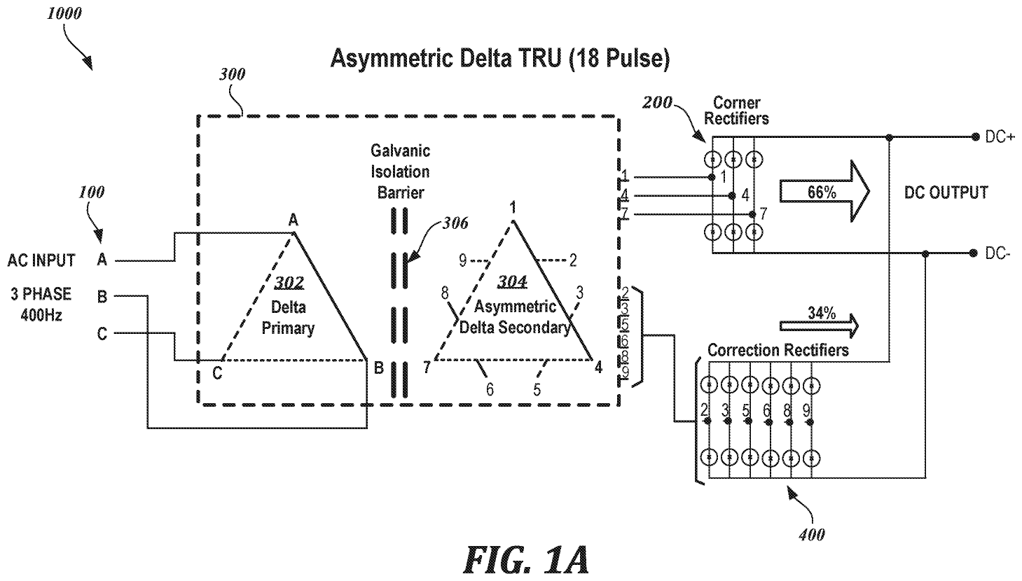

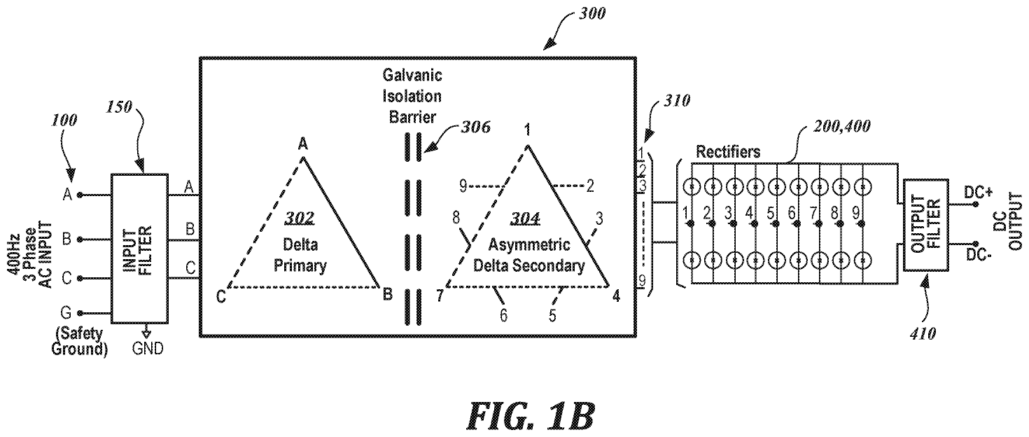

FIG. 1A illustrates an 18-pulse asymmetric delta TRU 1000 according to an embodiment of inventive technology. At the input side, 3-phase AC power 100 (typically 115 Volt or 230 Volt) is supplied to a transformer 300. The three input phases of the primary delta winding A, B, C are fed into the primary delta 302 and are transformed into the output phases 1, 4, 7 of the secondary delta 304. In some embodiments, the 3-phase delta primary 302 is coupled through a galvanic isolation 306 to a 3-phase asymmetric delta secondary 304. Galvanic isolation 306 limits fault propagation and allows TRU DC output returns to be tied directly to airframe regardless of generator's neutral voltage or impedance.

Power coming off the secondary delta winding taps 1, 4, 7 is fed into the corner rectifiers (also referred to as the main rectifiers) 200 that rectifies the majority of power coming from the secondary windings (e.g., about 66% in some cases) into a DC voltage (e.g., 540V). The secondary delta windings connected to winding taps 1, 4, 7 provide 6 pulses at the output of the main rectifier circuit 200. The remaining power may be fed off the secondary correction windings connected to winding taps 2, 3, 5, 6, 8, 9 to the correction rectifiers 400 (also referred to as the secondary rectifiers) that rectify the remaining power (e.g., about 34% in some cases), allowing power factor correction and harmonic cancellation of the 3-phase input currents. As a result, a significant size, weight, and dissipation reduction may be achieved in the transformer 300. The 66% vs. 34% distribution of power is an illustrative embodiment only, in other embodiments different fractions of power may be handled by the main rectifier 200 and the secondary rectifier 400. Secondary delta windings and secondary correction windings are collectively referred to as the secondary windings in this specification.

The rectifier circuits 200 and 400 include arrangements of diodes that rectify the input AC voltage into DC voltage. With the inventive technology transformer, the asymmetric delta TRU 1000 outputs high-quality DC (e.g., 540 Volt DC) while maintaining an 18-pulse input current waveform with high power factor and low harmonic content.

FIG. 1B also illustrates a TRU according to an embodiment of inventive technology. The 3-phase input A, B, C is fed through an input filter 150 into the transformer 300. In the illustrated embodiment, the 9 output phases (3 output phases from the secondary delta winding taps 1, 4, 7; and 6 output phases from the secondary correction winding taps 2, 3, 5, 6, 8, 9; collectively “output phases 310”) are coupled to rectifier circuits 200, 400 that rectify the incoming 9 phases into 18 pulses. Output phases of the individual secondary correction windings are asymmetric such that individual output phase voltages are controlled relative to the opposite secondary delta corner phase, and secondary output phase voltages are unbalanced relative to secondary neutral. The resulting DC voltage may be fed through an output electromagnetic interference (EMI) filter 410 before being delivered to the load(s). The illustrated TRU may convert a 230 Volt AC input to a 540 Volt DC output. In other embodiments, different AC input and DC output voltages may be produced.

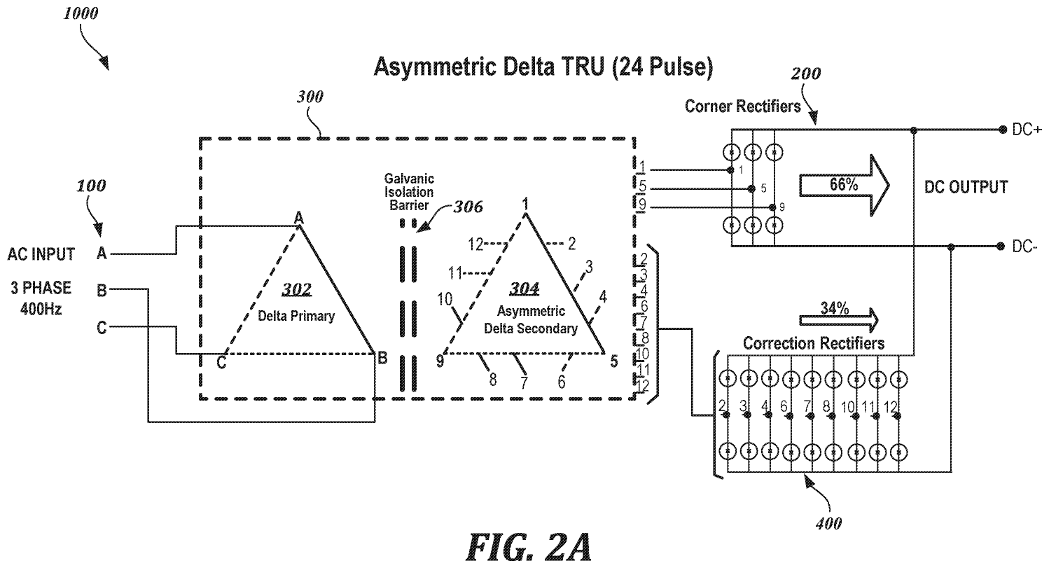

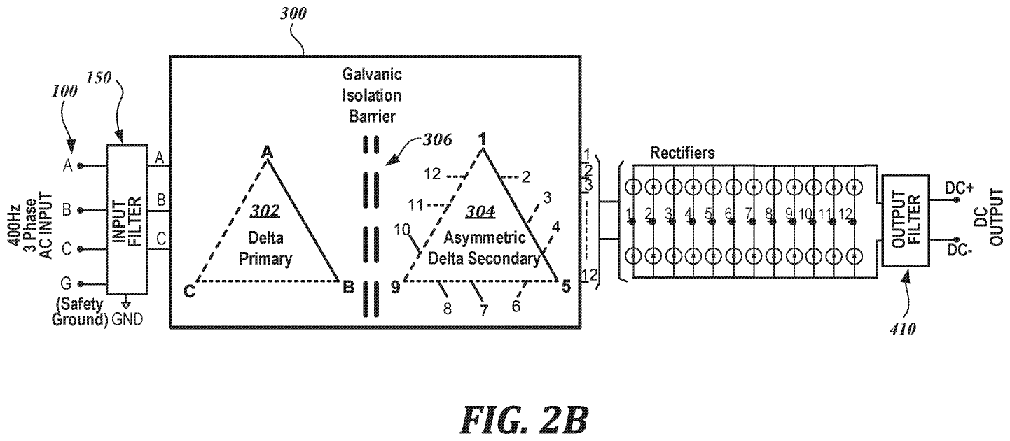

FIGS. 2A and 2B illustrate a 24-pulse asymmetric delta TRU 1000 according to an embodiment of inventive technology. Again, at the input side, 3-phase AC power 100 (typically 115 Volt or 230 Volt) is supplied to the transformer 300. The three input phases of the primary delta winding A, B, C are fed into the primary delta 302 and are transformed into the output phases 1, 5, 9 of the secondary delta 304. Power coming off the secondary delta winding taps 1, 5, 9 is fed into the corner rectifiers 200 that rectify the majority of power (e.g., about 66%) being processed by the TRU into a DC voltage (e.g., 540V). Therefore, the secondary delta winding taps 1, 5, 9 provide 6 pulses at the output of the main rectifier circuit 200. The secondary correction winding taps 2, 3, 4, 6, 7, 8, 10, 11, 12 provide additional 18 pulses to the secondary rectifiers 400 that rectify the remaining DC power (e.g., about 34%), allowing power factor correction and harmonic cancellation of the 3-phase input currents.

The 3-phase delta primary 302 is coupled through a galvanic isolation 306 to a 3-phase asymmetric delta secondary 304. As explained above, galvanic isolation 306 limits fault propagation and allows TRU DC output returns to be tied directly to airframe regardless of generator's neutral voltage or impedance.

FIG. 2B also illustrates a TRU 1000 according to an embodiment of inventive technology. Again, the 3-phase input A, B, C is fed through an input filter 150 into the transformer 300. In the illustrated embodiment, the 12 output phases (3 output phases from the secondary delta winding taps 1, 5, 9; and 9 output phases from the secondary correction winding taps 2, 3, 4, 6, 7, 8, 10, 11, 12) are coupled to a common rectifier circuit that rectifies the 12 phases into 24 pulses. The illustrated TRU may convert a 230 Volt AC input to a 540 Volt DC output. In other embodiments, different AC input and DC output voltages may be used.

FIGS. 1A-2B illustrate delta primary windings. However, in different embodiments wye primary windings may be used as the primary windings. Furthermore, the discussion herein focuses on the embodiments having 18-pulse and 24-pulse asymmetric transformers. However, the inventive technology may be applicable to other multi-pulse asymmetric transformers where the number of pulses is a multiple of 3, albeit with some tradeoffs. For example, an increasing number of pulses that necessitates an increasing number of secondary correction windings generally increases the size and weight of the TRU.

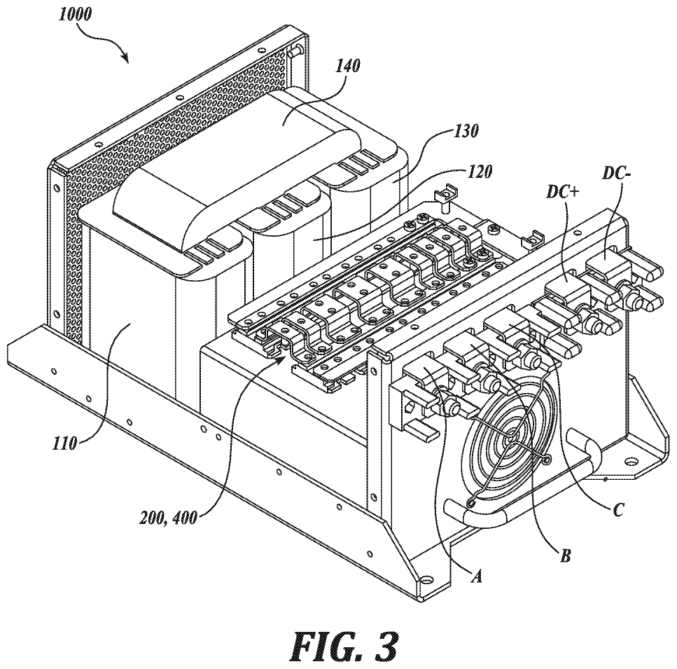

FIG. 3 illustrates a delta-wound transformer 1000 according to an embodiment of inventive technology. The inputs for the primary delta phases are marked as A, B, C at the front end of the TRU 1000. In some embodiments, the primary delta windings of the 3-phase input and the secondary delta windings are wound as 3 coils 110, 120 and 130. In the illustrated embodiment, coils 110, 120 and 130 share same ferromagnetic core 140.

The outputs of the secondary windings (e.g., 3 output phases from the secondary delta winding taps 1, 4, 7; and 6 output phases from the secondary correction winding taps 2, 3, 5, 6, 8, 9) are coupled to rectifier circuits 200, 400 to rectify the incoming 9 phases into 18 pulses. A person of ordinary skill would understand that analogous secondary windings 1-12 of the 24-pulse TRU may be connected to analogous rectifier circuits 200, 400 shown in FIGS. 2A and 2B. The DC outputs DC+ and DC− are marked at the front end of the TRU 1000.

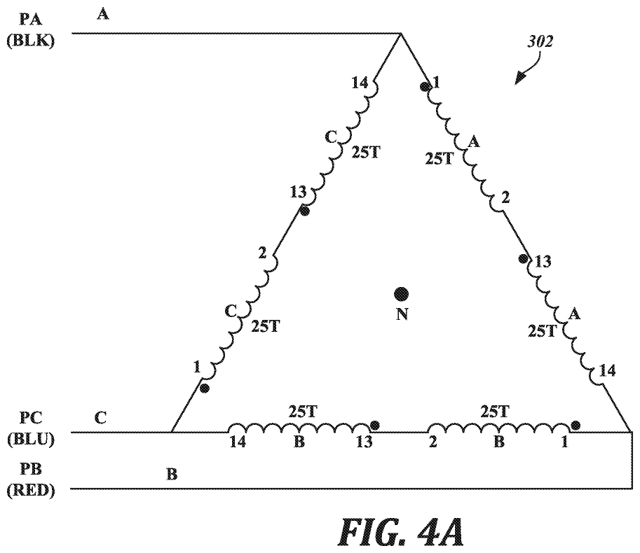

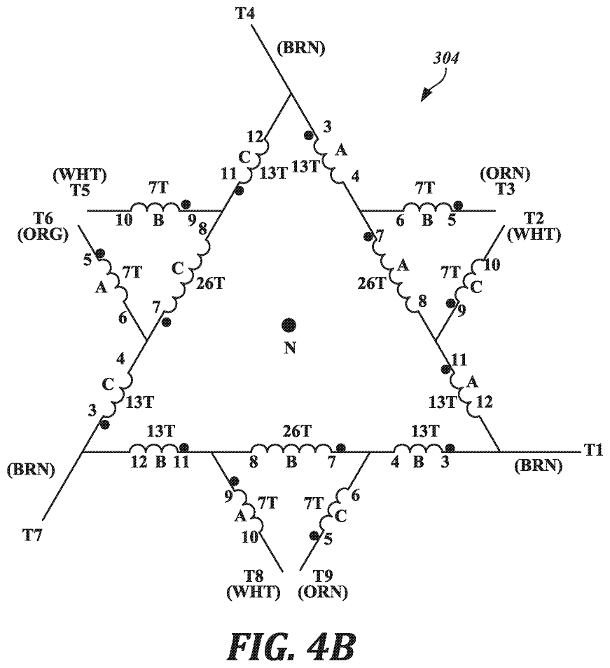

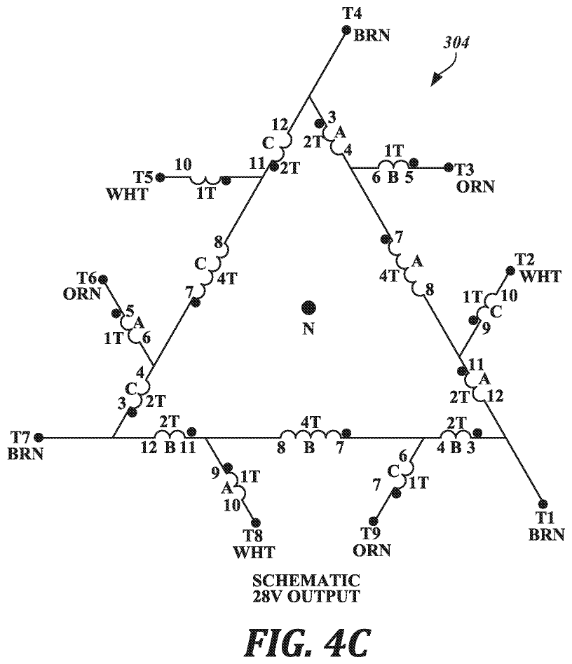

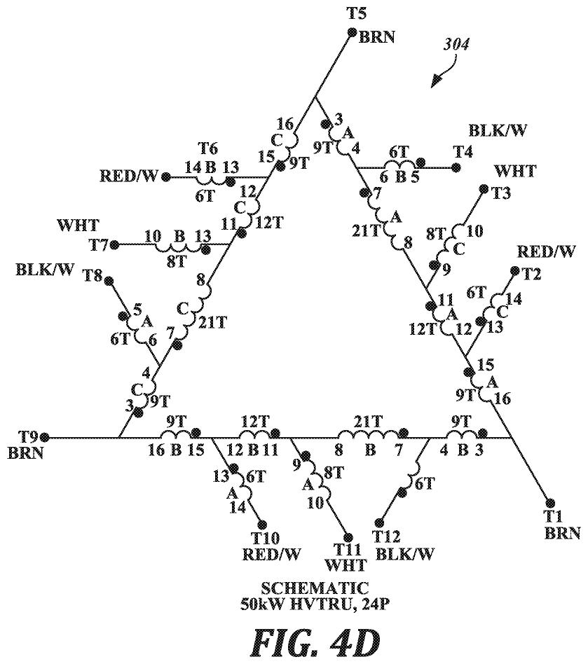

FIG. 4A illustrates primary delta windings 302 of a multi-pulse asymmetric transformer according to an embodiment of inventive technology. The primary delta windings 302 include phases A, B and C. The illustrated primary delta windings 302 include 50 turns each, but in other embodiments different number of turns are also possible. FIGS. 4B and 4C illustrate secondary 304 with delta windings and secondary correction windings of an 18-pulse asymmetric transformer according to different embodiments of inventive technology. The illustrated secondary windings (delta and correction) include 9 output taps (T1-T9) for the 9 output phases that include 3 main phases and 6 correction phases (also referred to as auxiliary phases) of the transformer. The topology orientation is exemplary, and different topology may apply in different embodiments. The secondary delta windings and secondary correction windings are marked with A, B and C to signify their phase correspondence with respect to the primary delta phases A, B and C.

The number of turns for each winding of the illustrated embodiment is labeled adjacent to the winding. In FIG. 4B, the serial windings along the T1-coil (B-phase), corresponding to the secondary delta winding, have 13, 26 and 13 turns in series. Each of the secondary correction windings that are connected to taps T3 and T5 have 7 turns. Similarly, the serial windings along the T4-coil (A-phase) of the secondary delta winding also have 13, 26 and 13 turns in series. The corresponding secondary correction windings providing taps T6 and T8 each have 7 turns. The C-phase secondary windings have analogous number and distribution of turns.

In FIG. 4C, the serial windings along the T1-coil (A-phase), corresponding to the secondary delta winding, have 2, 4 and 2 turns in series. The illustrated embodiment, having a relatively small number of turns in the secondary delta winding, may be useful for a relatively low DC output of 28V. Each of the secondary correction windings that are connected to, e.g., taps T6 and T8 of the B-phase, has 1 turn. The B-phase and C-phase secondary windings (delta and correction) have analogous number and distribution of turns.

FIG. 4D illustrates secondary delta windings and secondary correction windings of a 24-pulse asymmetric transformer according to an embodiment of inventive technology. The illustrated secondary windings (delta and correction) include 12 output taps (T1-T12) for the 12 output phases that include 3 main phases and 9 correction phases (also referred to as auxiliary phases) of the transformer. The topology orientation is exemplary, and different topology may apply in different embodiments. The secondary delta windings and secondary correction windings are marked with A, B and C to signify their phase correspondence with respect to the primary delta phases A, B and C.

For example, the serial windings along the T5-coil (C-phase), corresponding to the secondary delta winding, have 9, 12, 21 and 9 turns in series. The secondary correction windings that are connected to taps T3, T2 and T12 have 8 turns, 6 turns and 6 turns, respectively. Similarly, the serial windings along the T1-coil (A-phase) of the secondary delta winding also have 9, 12, 21 and 9 turns in series. The corresponding secondary correction windings that are connected to taps T8, T10 and T11 have 6 turns, 6 turns and 8 turns, respectively. The B-phase secondary delta and secondary correction windings have analogous number and distribution of turns.

In some embodiments, the inventive transformer may be characterized by following parameters:
Input voltage: 115 Vac, 3-phase, 360-800 Hz, MIL-STD-704F
Output voltage: nominal 270Vdc (unregulated)
Output power: 45 KW
Efficiency: >96% at >50% load, normal AC input range
Power Factor: >0.95 at >25% load
Voltage Ripple: <6 Vpp
Total harmonic distortion (THDi): 18 pulse <7%
High current overload capability 150% for 1 minute 200% for 5 seconds
Reliability: >200 k hrs MTBF (assuming external forced airflow provided)

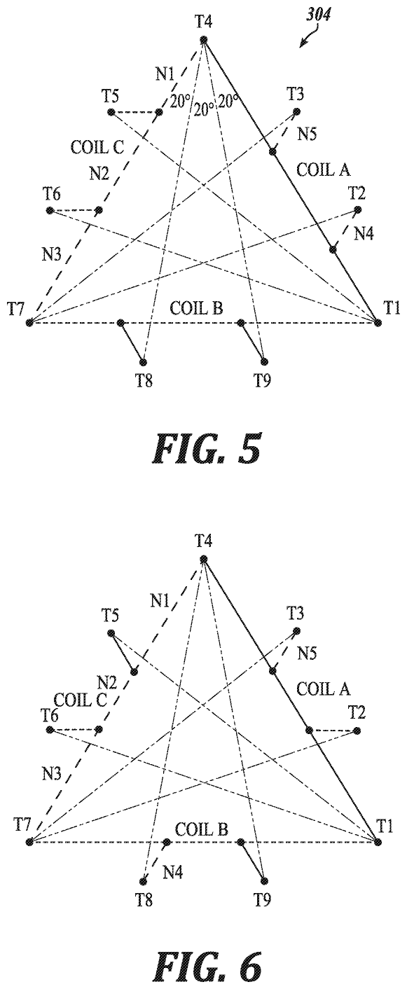

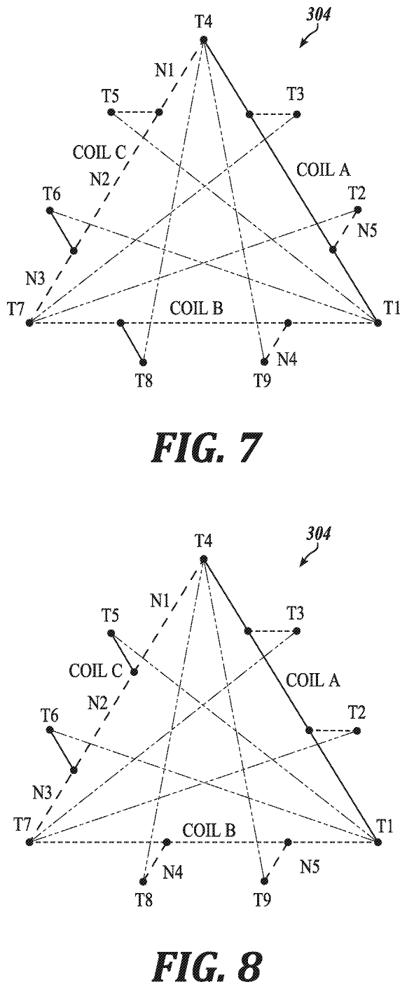

FIGS. 5-8 illustrate secondary delta and correction windings for an 18-pulse asymmetric transformer according to an embodiment of inventive technology. For example, FIG. 7 illustrates delta-wound transformer topology diagram for the 18-pulse transformer of FIGS. 1A and 1B based on the primary delta windings shown in FIG. 4A and the secondary delta and secondary correction windings shown in FIG. 4B. Each side of the secondary delta has 3 serial windings. For example, looking at the phase C, the secondary delta windings include serial windings N1, N2 and N3 that are interposed between taps T4 and T7. Analogous windings are interposed between T4 and T1 for the phase A, and between T1 and T7 for the phase B, but are unlabeled on the diagram to simplify the drawings and to reduce clutter.

The secondary correction windings for the phase C are labeled N4 and N5. Secondary delta windings A and B and their corresponding secondary correction windings are also not labeled with ‘Nx’ in order to reduce clutter in the drawings. However, a reader will recognize that, for example, the secondary correction windings N4 an N5 are drawn to be parallel to the secondary delta winding C (whose phase these secondary correction windings ‘correct’). Analogously, the secondary correction windings that correspond to each of the secondary delta windings A and B are also drawn to be parallel to their respective A and B secondary delta windings. This convention is followed throughout FIGS. 5-12.

A sample method for determining the phase-to-phase voltage in an asymmetric transformer is described as follows with reference to FIGS. 5-8. The sample method includes drawing a vector from the end of each secondary correction winding (e.g., taps T5, T6) to the opposite vertex of the equilateral triangle (e.g., vertex where phase windings A and B intersect, i.e., vertex T1). These vectors represent the transformer output phases. Each vector's length is proportional to the corresponding output phase's magnitude relative to the phase represented by the opposite vertex of the triangle (not relative to neutral as in the symmetric transformer)—this phase-to-phase voltage is presented to the bridge rectifier as a conduction pair as shown in Table 2. In some embodiments, triplen harmonic mitigation is guaranteed by the secondary delta winding formed by N1-N3 turns ratios, which provide a suitable winding configuration for triplen harmonics mitigation.

As noted above, the desired phase shifting of transformer output phases is obtained from the secondary correction windings tapped at the select locations between the serial windings traversing the input phases and providing outputs at T2, T3, T5, T6, T8, and T9. The coil that the secondary correction winding is wound upon and winding polarity of the secondary correction winding determine the direction of the phase shift the secondary correction winding provides to its output phase. Each correction winding's turns ratio along with its tapping point between the serial windings determines the final phase angle and magnitude of its output phase. These output phase magnitudes and phases are illustrated diagrammatically by the lines.

For the 18-pulse behavior, nominal 20° spacing is desired between adjacent phases. As explained above, practical output phase magnitude will depend on transformer construction, parasitics (e.g., leakage inductance), and use case (e.g., source and load impedance).

For the embodiment illustrated in FIG. 5, the secondary turn ratios are shown in Table 1 below. The turns ratio for a given secondary winding may be defined as the ratio of the winding's turns to the total turns between each secondary corner phase. This is not to be confused with the transformer's primary to secondary turns ratio, which in its simplest form is the ratio of the primary delta turns count to the secondary delta turns count. In some embodiments, the illustrated turns ratios may be approximate, because the optimum turns ratios may vary with transformer construction, different parasitics, and use case. As a result, a practically-implemented turns count may vary with the selected transformer core.

TABLE 1
Turn Ratios in FIG. 5

| | Winding | | | | |
|---|---|---|---|---|---|
| | N1 | N2 | N3 | N4 | N5 |
| Turns Ratio | 0.26 | 0.35 | 0.39 | 0.14 | 0.14 |

For the embodiments illustrated in FIGS. 6-8, the turn ratios are shown below in Tables 2-4, respectively.

TABLE 2
Turn Ratios in FIG. 6

| | Winding | | | | |
|---|---|---|---|---|---|
| | N1 | N2 | N3 | N4 | N5 |
| Turns Ratio | 0.39 | 0.21 | 0.39 | 0.14 | 0.14 |

TABLE 3
Turn Ratios in FIG. 7

| | Winding | | | | |
|---|---|---|---|---|---|
| | N1 | N2 | N3 | N4 | N5 |
| Turns Ratio | 0.26 | 0.48 | 0.26 | 0.14 | 0.14 |

TABLE 4
Turn Ratios in FIG. 8

| | Winding | | | | |
|---|---|---|---|---|---|
| | N1 | N2 | N3 | N4 | N5 |
| Turns Ratio | 0.39 | 0.35 | 0.26 | 0.14 | 0.14 |

Other turn ratios are possible in different embodiments. The examples shown in Tables 1-4 should be understood as non-limiting examples.

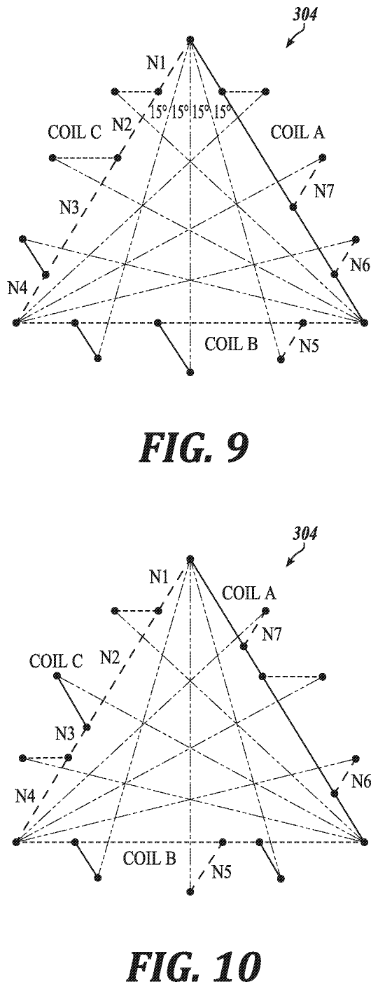

FIGS. 9-16 illustrate secondary delta and secondary correction windings for a 24-pulse asymmetric transformer according to an embodiment of inventive technology. A sample 24-pulse asymmetric transformer is shown in FIGS. 2A and 2B above. Sample primary delta windings are shown in FIG. 4A, and sample secondary delta and secondary correction windings are shown in FIG. 4D.

FIG. 9 illustrates delta-wound transformer topology diagram for the 24-pulse transformer. Each side of the secondary delta has 4 serial windings. For example, looking at the phase C, the secondary delta windings include serial windings N1, N2, N3 and N4. Analogous serial windings are shown for the phases A and B, but are unlabeled on the diagram to reduce clutter. The desired phase shifting of transformer output phases is obtained from the secondary correction windings tapped at the select locations between the serial windings traversing the input phases, analogous to the method explained in conjunction with the 18-pulse transformer above. The coil that the secondary correction winding is wound upon and winding polarity of the secondary correction winding determine the direction of the phase shift the secondary correction winding provides to its output phase. Each secondary winding's turns ratio along with its tapping point between the serial windings determines the final phase angle and magnitude of its output phase. These output phase magnitudes and phases are illustrated diagrammatically by the lines in FIGS. 9-16. For the 24-pulse behavior, nominal 15° spacing is desired between adjacent phases.

For the embodiments illustrated in FIGS. 9-16, the secondary turns ratios are shown below in Tables 5-12, respectively.

TABLE 5
Turn Ratios in FIG. 9

| Winding | N1 | N2 | N3 | N4 | N5 | N6 | N7 |
|---|---|---|---|---|---|---|---|
| Turns Ratio | 0.17 | 0.24 | 0.42 | 0.17 | 0.13 | 0.13 | 0.18 |

TABLE 6
Turn Ratios in FIG. 10

| Winding | N1 | N2 | N3 | N4 | N5 | N6 | N7 |
|---|---|---|---|---|---|---|---|
| Turns Ratio | 0.17 | 0.42 | 0.11 | 0.30 | 0.18 | 0.13 | 0.13 |

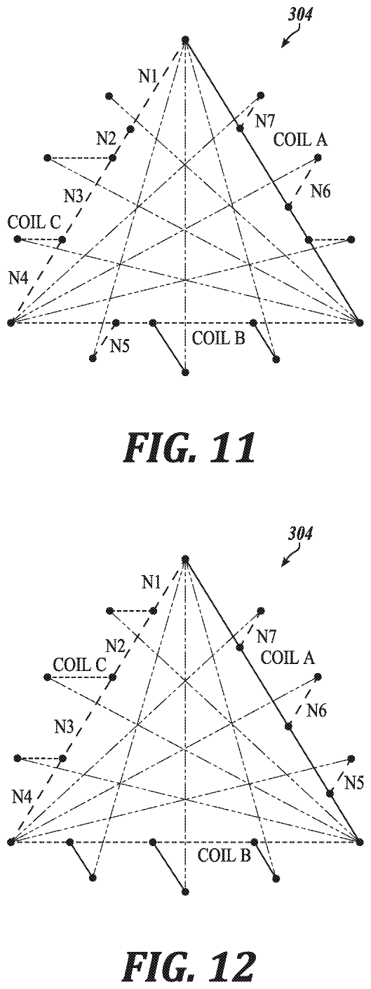

TABLE 7
Turn Ratios in FIG. 11

| Winding | N1 | N2 | N3 | N4 | N5 | N6 | N7 |
|---|---|---|---|---|---|---|---|
| Turns Ratio | 0.30 | 0.11 | 0.29 | 0.30 | 0.13 | 0.18 | 0.13 |

TABLE 8
Turn Ratios in FIG. 12

| Winding | N1 | N2 | N3 | N4 | N5 | N6 | N7 |
|---|---|---|---|---|---|---|---|
| Turns Ratio | 0.17 | 0.24 | 0.29 | 0.30 | 0.13 | 0.18 | 0.13 |

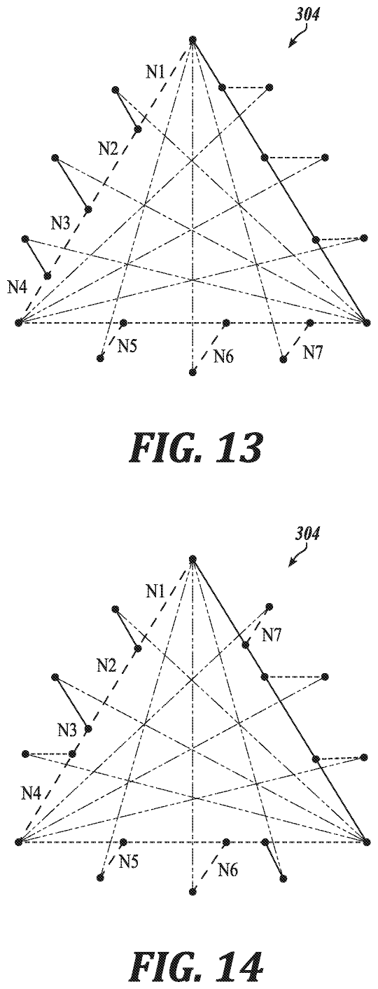

TABLE 9
Turn Ratios in FIG. 13

| Winding | N1 | N2 | N3 | N4 | N5 | N6 | N7 |
|---|---|---|---|---|---|---|---|
| Turns Ratio | 0.30 | 0.29 | 0.24 | 0.17 | 0.13 | 0.18 | 0.13 |

TABLE 10
Turn Ratios in FIG. 14

| Winding | N1 | N2 | N3 | N4 | N5 | N6 | N7 |
|---|---|---|---|---|---|---|---|
| Turns Ratio | 0.30 | 0.29 | 0.11 | 0.30 | 0.13 | 0.18 | 0.13 |

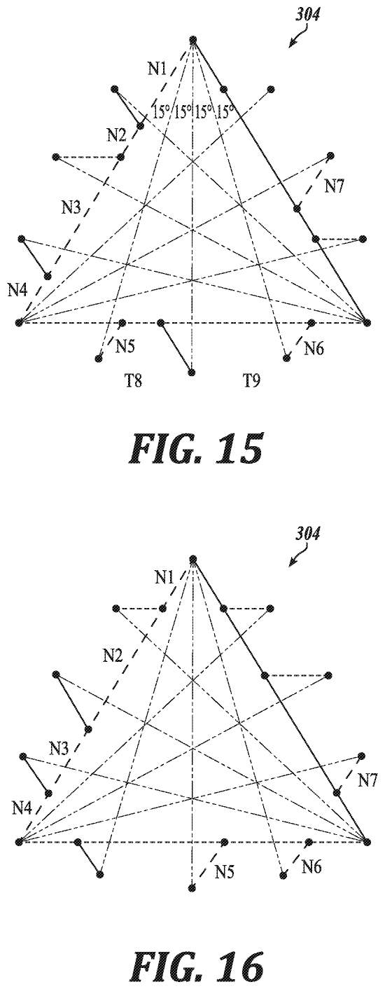

TABLE 11
Turn Ratios in FIG. 15

| Winding | N1 | N2 | N3 | N4 | N5 | N6 | N7 |
|---|---|---|---|---|---|---|---|
| Turns Ratio | 0.30 | 0.11 | 0.42 | 0.17 | 0.13 | 0.13 | 0.18 |

TABLE 12
Turn Ratios in FIG. 16

| Winding | N1 | N2 | N3 | N4 | N5 | N6 | N7 |
|---|---|---|---|---|---|---|---|
| Turns Ratio | 0.17 | 0.42 | 0.24 | 0.17 | 0.18 | 0.13 | 0.13 |

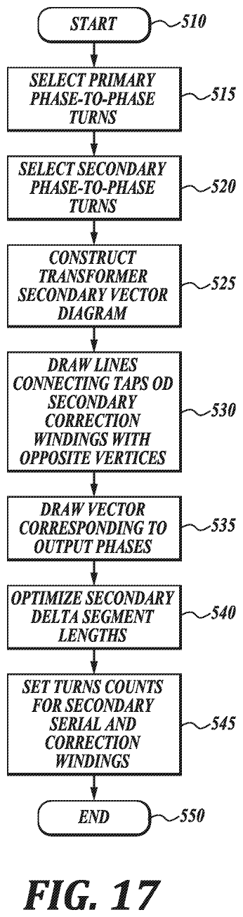

FIG. 17 is a flowchart of a method for designing a multi-pulse asymmetric transformer according to embodiments of inventive technology. In particular, illustrated method outlines a design process of selecting turns ratios for proper output phase magnitudes and spacing for asymmetric 24-pulse operation. In different embodiments, illustrated method may include additional steps or may include other steps not shown in the flowchart.

The method may start in block 510. In blocks 515 and 520, primary and secondary phase-to-phase turns counts are selected. These turns count selection is made so to maintain acceptable flux density for selected core, operating frequency, operating voltage, and input to output voltage scaling.

In block 525, transformer vector diagram is constructed for the secondary windings using an equilateral triangle with leg lengths proportional to the number of turns between corner phases. Each side of the triangle represents a complete delta winding and consists of 3 segments (for an 18-pulse asymmetric transformer) or 4 segments (for a 24-pulse asymmetric transformer) between each pair of triangle vertices (see, e.g., FIGS. 5 and 9). Each segment represents a serial winding and has a length proportional to the turns count of the applicable serial winding. The points between the vertices of each leg where segments meet represent locations of the secondary correction winding tap.

In block 530, lines are drawn representing secondary correction windings off of each tap location between triangle vertices. Each line is a vector with phase equivalent to the phase of the coil the secondary correction winding is wound upon and length proportional to secondary correction windings turn count. Each vector runs parallel to one of the sides of the triangle. Each winding's turns ratio is equivalent to the turns count of the secondary correction winding divided by the turns count of the full delta winding. This is illustrated on the transformer vector diagram as the length of the correction winding vector to the length of a full leg of the equilateral triangle.

In block 535, a vector is drawn from the end of each correction winding vector to the opposite vertex of the equilateral triangle. These vectors represent the transformer output phases. Each vector's length is proportional to the corresponding output phase's magnitude relative to the phase represented by the opposite vertex of the triangle. Vectors can be drawn from each output tap to neutral which accurately indicate output phase voltage relative to neutral, but due to the nature of the asymmetric design of these phases to neutral voltages will be uneven. Controlling phase-to-phase voltages rather than phase-to-neutral is a difference between asymmetric and symmetric design approaches.

In block 540, delta segment lengths are optimized while maintaining constant total delta length to adjust tap locations. In some embodiments, correction winding vector lengths are adjusted until output phase vector lengths are approximately equal to the lengths of each side of the equilateral triangle, and all vectors originating from each triangle vertex maintain approximately 20° phase spacing for the 18-pulse transformer and 15° phase spacing for the 24-pulse transformer. Examples of complete transformer vector drawings created using this method can be seen in FIGS. 5-12.

In block 545, serial and correction windings turn counts are set based on the final lengths of each serial winding line segment and correction winding vector in the transformer vector drawing. The method may end in block 545.

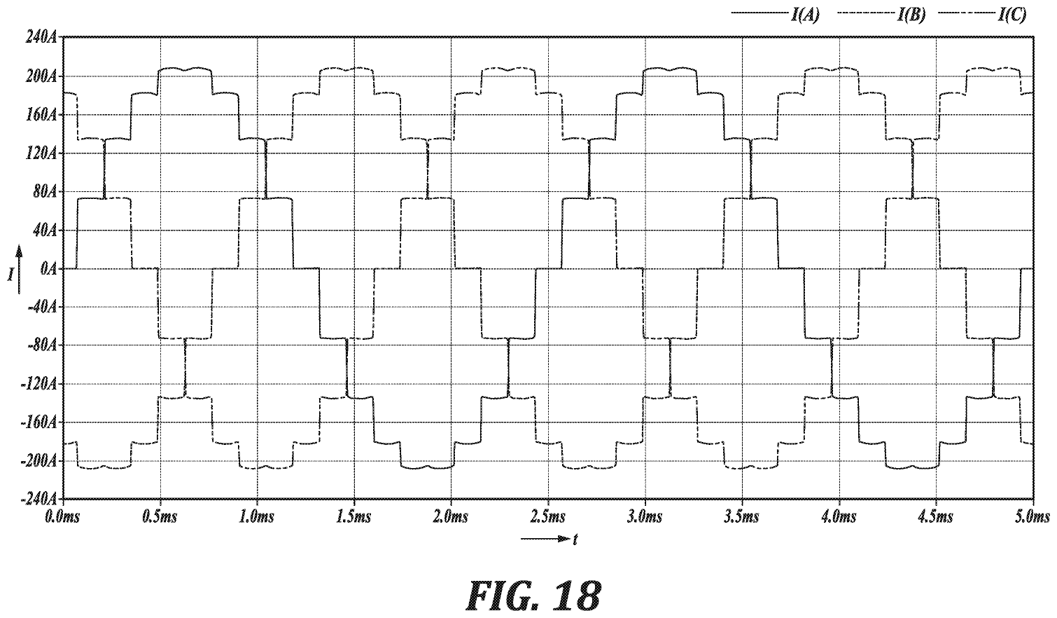

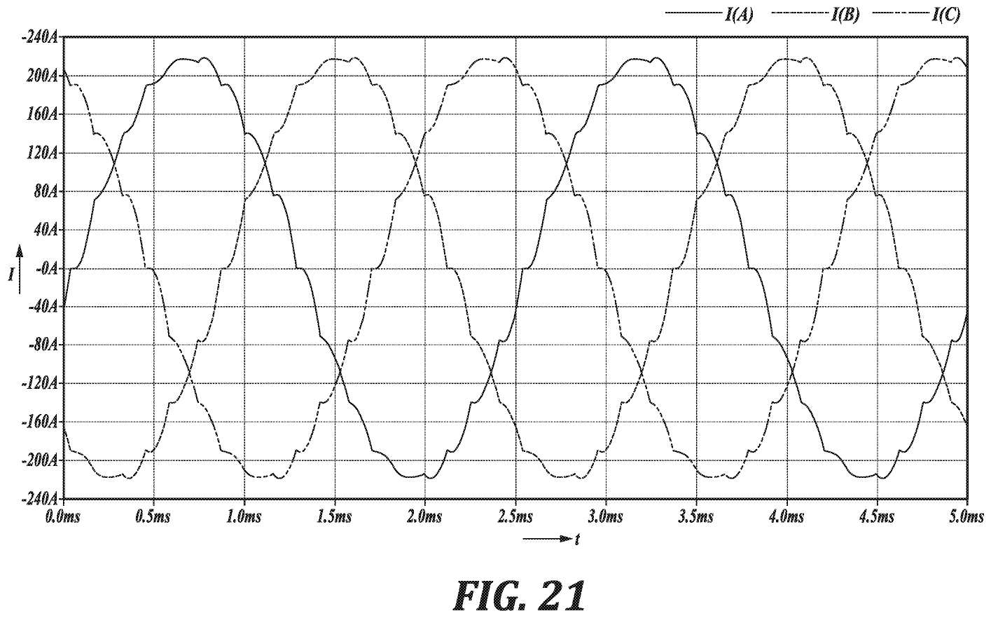

FIGS. 18-20 are graphs of simulated current waveforms for an 18-pulse asymmetric TRU utilizing an ideal transformer of the topology depicted in FIGS. 4A and 4B. The simulated asymmetric TRU is called “ideal” because non-idealities such as leakage inductance and winding resistance are neglected. A person of ordinary skill would understand that analogous graphs can be generated for a 24-pulse asymmetric TRU. FIG. 21 is a graph of actual 3-phase input current waveforms according to an embodiment of inventive technology. In each of these graphs, the horizontal axis shows the elapsed time. The vertical axis shows electrical current in Amperes.

In particular, FIG. 18 is a graph of simulated 3-phase input current waveforms for an 18-pulse asymmetric TRU utilizing an ideal transformer of the topology depicted in FIGS. 4A and 4B. Ideal transformer without leakage inductance or winding resistance exhibits with a sinusoidal voltage input a stepped current waveform approximating a sine wave with 18 “steps” or “pulses”. This is the result of bridge rectifier conduction pairs switching every 20°. Addition of leakage inductance and winding resistance serves to smooth the waveform so that end result is nearly sinusoidal (as shown below in FIG. 21).

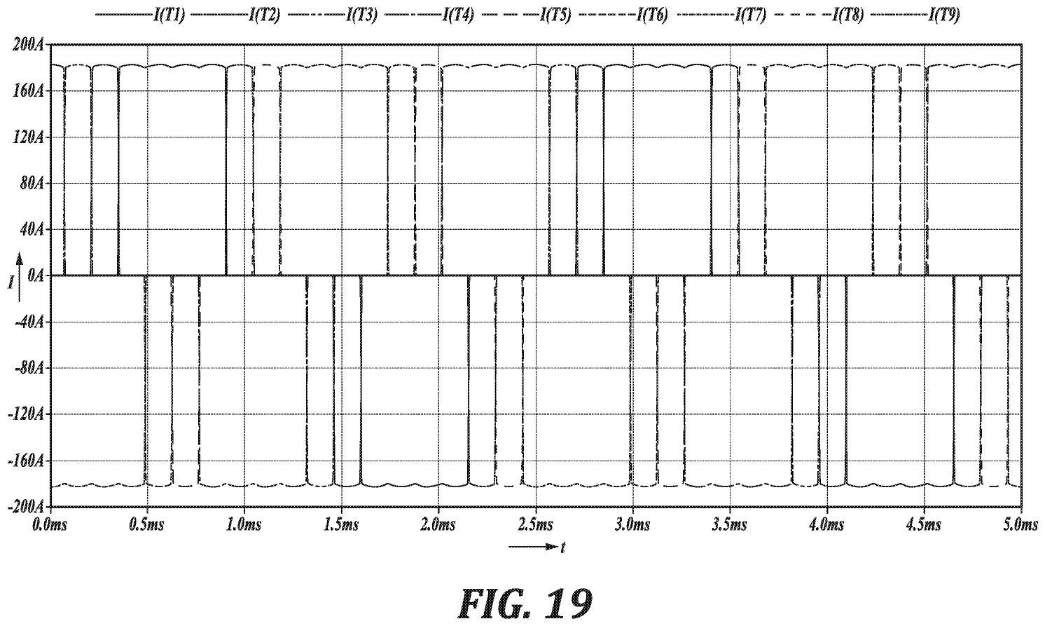

FIG. 19 is a graph of simulated rectifier bridge currents for an 18-pulse asymmetric ATRU during one full electrical cycle. The 20° spacing of bridge rectifier conduction pairs can be seen as each conductive pair conducts for about 139 microseconds, or approximately 20 electrical degrees of the given 400 Hz cycle, which has a period of 2.5 ms. Additionally, it can be seen in FIG. 18 that each secondary delta winding connection to the bridge rectifier conducts current for 4 consecutive pulses, whereas each secondary correction winding only conducts current for 1 pulse in a given half-cycle. This is indicative of the majority of power being processed by the TRU coming from the secondary delta windings, and minority of power being coming from the secondary correction windings.

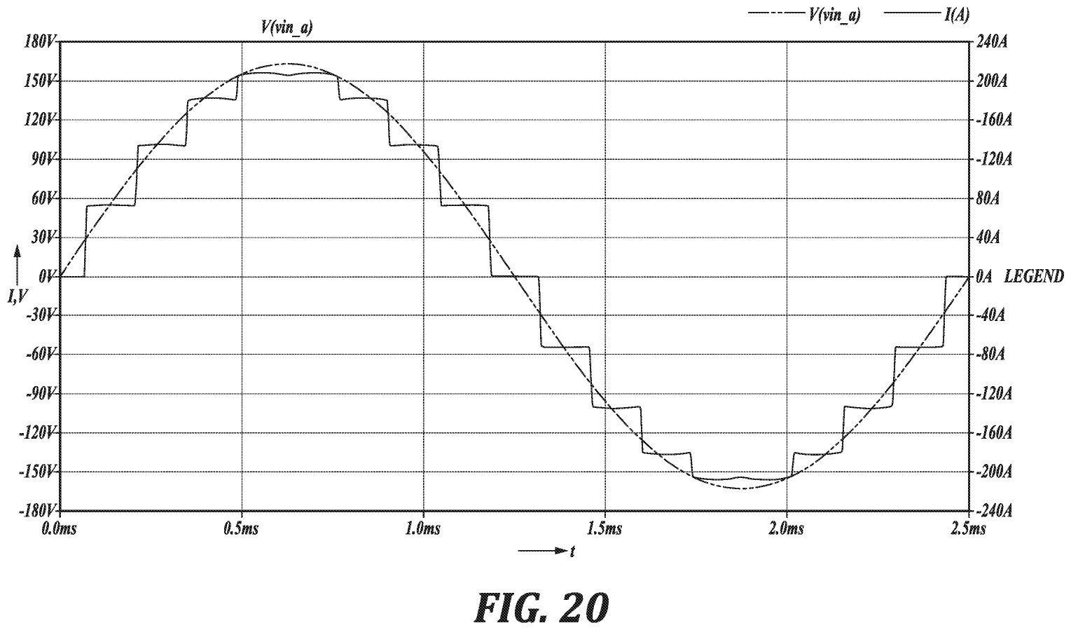

FIG. 20 is a graph of simulated phase A input voltage and current for an 18-pulse asymmetric TRU utilizing an ideal transformer of the topology depicted in FIGS. 4A and 4B.

FIG. 21 is a graph of simulated 3-phase input current waveforms with expected TRU non-idealities including winding resistance and leakage inductance included. In the illustrated embodiment, the actual current waveforms are smoother (indicating lower harmonic distortion) than the ideal input current waveforms shown in FIG. 18. This is because the presence of small amounts leakage inductance can serve to smooth the input current waveform. In general, leakage inductance should generally be kept as small as possible, though. As can be seen in FIGS. 19 and 20, the secondary correction windings carry pulse currents of high magnitude and short duration. If leakage inductance is allowed to be too large, these pulse currents cannot reach their full magnitude, and the 18-pulse operation may be degraded such that the effective pulse count is reduced and the performance of the 18-pulse ATRU starts to approximate a 12-pulse solution.

Based on the above analysis and simulation, it can be observed that the 18-pulse and 24-pulse asymmetric delta TRUs provide distinct advantages for both HVTRU and 28V TRU applications. The inventive technology offers significant improvement to power quality relative to legacy 12-pulse delta-wye solutions with comparable weight and efficiency, and it offers slightly lower size and weight and significantly lower cost than a 24-pulse delta-hex solution since it requires 3 less windings per coil and does not require discrete output inductors for proper phase spacing. It is estimated that labor ratios of a delta-delta-wye solution, 18P asymmetric delta, and 24P delta hex are approximately 1:1.45:1.76.

Many embodiments of the technology described above may take the form of computer- or controller-executable instructions, including routines executed by a programmable computer or controller. Those skilled in the relevant art will appreciate that the technology can be practiced on computer/controller systems other than those shown and described above. The technology can be embodied in a special-purpose computer, controller or data processor that is specifically programmed, configured or constructed to perform one or more of the computer-executable instructions described above. Accordingly, the terms “computer” and “controller” as generally used herein refer to any data processor and can include Internet appliances and hand-held devices (including palm-top computers, wearable computers, cellular or mobile phones, multi-processor systems, processor-based or programmable consumer electronics, network computers, mini computers and the like).

From the foregoing, it will be appreciated that specific embodiments of the technology have been described herein for purposes of illustration, but that various modifications may be made without deviating from the disclosure. Moreover, while various advantages and features associated with certain embodiments have been described above in the context of those embodiments, other embodiments may also exhibit such advantages and/or features, and not all embodiments need necessarily exhibit such advantages and/or features to fall within the scope of the technology. Where methods are described, the methods may include more, fewer, or other steps. Additionally, steps may be performed in any suitable order. Accordingly, the disclosure can encompass other embodiments not expressly shown or described herein. In the context of this disclosure, the term “about” means +/−5% of the stated value.

For the purposes of the present disclosure, lists of two or more elements of the form, for example, “at least one of A, B, and C,” is intended to mean (A), (B), (C), (A and B), (A and C), (B and C), or (A, B, and C), and further includes all similar permutations when any other quantity of elements is listed.

1. A Transformer Rectifier Unit (TRU), comprising:
an asymmetric transformer, comprising:
a first coil, a second coil and a third coil, wherein each coil comprises a primary winding and a secondary winding, each secondary winding being an asymmetric secondary winding, and wherein each coil is configured for being energized at its corresponding input phase, and
a galvanic isolation electrically isolating primary windings from secondary windings, wherein:
a first secondary winding comprises a first secondary delta winding and a first plurality of secondary correction windings coupled to a first primary winding;
a second secondary winding comprises a second secondary delta winding and a second plurality of secondary correction windings coupled to a second primary winding; and
a third secondary winding comprises a third secondary delta winding and a third plurality of secondary correction windings coupled to a third primary winding; and
a bridge rectifier comprising a plurality of rectifiers coupled to respective individual correction windings,
wherein output phases of individual secondary correction windings are asymmetric such that individual output phase voltages are controlled relative to an opposite secondary delta corner phase, and wherein the output phase voltages are unbalanced relative to secondary neutral.

2. The TRU of claim 1, wherein the transformer is an 18-pulse transformer having a 3-phase input power, and an isolated 9-phase output.

3. The TRU of claim 2, wherein each plurality of secondary correction windings comprises 2 secondary correction windings.

4. The TRU of claim 3, wherein tap points of each plurality of correction windings separate each corresponding coil of the secondary delta winding into 3 segments.

5. The TRU of claim 2, wherein individual phase voltages are about 20° offset from one phase to a next adjacent phase at the bridge rectifier.

6. The TRU of claim 1, wherein the transformer is a 24-pulse transformer having a 3-phase input power, and an isolated 12-phase output.

7. The TRU of claim 6, wherein each plurality of secondary correction windings comprises 3 secondary correction windings.

8. The TRU of claim 7, wherein tap points of each plurality of correction windings separate each corresponding coil of the secondary delta winding into 4 segments.

9. The TRU of claim 6, wherein individual phase voltages are about 15° offset from one phase to a next adjacent phase at the bridge rectifier.

10. The TRU of claim 1, wherein the bridge rectifier comprises:
a main rectifier configured for rectifying AC voltages of the secondary delta windings; and
a secondary rectifier configured for rectifying AC voltages of the correction windings.

11. The TRU of claim 10, wherein the main rectifier provides about 66% of DC power, and wherein the secondary rectifier provides about 34% of DC power.

12. A method for designing an asymmetric transformer having a first coil, a second coil, a third coil, and a galvanic isolation, wherein each coil comprises a primary winding and a secondary winding, wherein each secondary winding is an asymmetric secondary winding comprising a secondary delta winding and a plurality of secondary correction windings, and wherein the galvanic isolation is configured for electrically isolating primary windings from secondary windings, the method comprising:
selecting turns count for the primary windings of the coils;
selecting turns count for each of the secondary delta windings of the coils;
selecting tap points for secondary correction windings along a first secondary delta winding of the first coil, a second secondary delta winding of the second coil and a third secondary delta winding of the third coil, wherein the tap points divide each of the first secondary delta winding, the second secondary delta winding and the third secondary delta winding into segments;
constructing transformer vector diagram using an equilateral triangle with leg lengths proportional to a number of turns between secondary corner phases, wherein each side of the triangle represents one of the first, second and third secondary delta windings;
drawing lines representing individual secondary correction windings off of each tap location along the first, second and third secondary delta winding, wherein:
each line is represented as a vector of a first plurality of vectors with a phase equivalent to a phase of the coil the secondary correction winding is wound upon and length proportional to secondary correction windings turns count, and
each vector of the first plurality of vectors runs parallel to one of sides of the triangle;
determining each secondary correction winding's turns ratio by the length of a corresponding vector of the first plurality of vectors; and
determining a number of turns in each second correction winding as a multiple of the turns ratio and the number of turns in the complete secondary delta winding.

13. The method of claim 12, further comprising determining output phases of the transformer by:
drawing a vector of a second plurality of vectors from an end of each correction winding vector to an opposite vertex of the equilateral triangle; and
determining an output phase of each correction winding by a length of a corresponding vector of a second plurality of vectors.

14. The method of claim 12, wherein an output phase of each correction winding is proportional to a magnitude of a corresponding output phase relative to a phase represented by an opposite vertex of the triangle.

15. The method of claim 12, wherein the transformer is an 18-pulse transformer having a 3-phase input power, and an isolated 9-phase output.

16. The method of claim 15, wherein each plurality of secondary correction windings comprises 2 secondary correction windings, and wherein tap points of each plurality of correction windings separate each corresponding coil of the secondary delta winding into 3 segments, and wherein individual phase voltages are about 20° offset from one phase to a next adjacent phase at a bridge rectifier.

17. The method of claim 16, wherein the 3 segments along individual coils of the secondary delta winding have turns ratios of N1=0.26, N2=0.35, and N3=0.39; and wherein individual correction windings have turns ratios of N4=0.14, and N5=0.14; where the turns ratio is defined as a number of turns in a segment or in a correction winding divided by a total number of turns in the coil of the delta winding.

18. The method of claim 12, wherein the transformer is a 24-pulse transformer having a 3-phase input power, and an isolated 12-phase output.

19. The method of claim 18, wherein each plurality of secondary correction windings comprises 3 secondary correction windings, and wherein tap points of each plurality of correction windings separate each corresponding coil of the secondary delta winding into 4 segments, and wherein individual phase voltages are about 15° offset from one phase to a next adjacent phase at a bridge rectifier.

20. The method of claim 16, wherein the 3 segments along individual coils of the secondary delta winding have turns ratios of N1=0.17, N2=0.24, N3=0.42, and N4=0.17; and wherein individual correction windings have turns ratios of N5=0.13, N6=0.13 and N7=0.18; where the turns ratio is defined as a number of turns in a segment or in a correction winding divided by a total number of turns in the coil of the delta winding.
